(19) United States
(12) Patent Application Publication
(10) Pub. No.: US 2026/0094569 A1
(43) Pub. Date: Apr. 2, 2026

(54) PIXEL CIRCUIT AND DISPLAY DEVICE INCLUDING THE SAME

(71) Applicant: LG Display Co., Ltd., Seoul (KR)

(72) Inventors: Hyung Uk JANG, Paju-si (KR); Kyoung Hwan KIM, Paju-si (KR)

(73) Assignee: LG Display Co., Ltd., Seoul (KR)

(21) Appl. No.: 19/268,775

(22) Filed: Jul. 14, 2025

(30) Foreign Application Priority Data
Sep. 27, 2024 (KR) 10-2024-0131542

(51) Int. Cl. G09G 3/3233

(52) U.S. Cl. CPC G09G 3/3233; G09G 2300/0819; G09G 2300/0852; G09G 2300/0861; G09G 2310/08; G09G 2320/045; G09G 2330/021

(57) ABSTRACT

A pixel circuit and a display device including the same are discussed. The pixel circuit includes a light-emitting element, a first driving element configured to drive the light-emitting element, a second driving element configured to drive the first driving element, a capacitor connected to a gate electrode of the second driving element, a first switch element configured to apply an initialization voltage to a second electrode of the capacitor, a second switch element configured to apply a data voltage to a first electrode of the capacitor, a third switch element configured to apply an off voltage to the first electrode of the capacitor, a fourth switch element connected between the second electrode of the capacitor and a first electrode of the second driving element, and a fifth switch element configured to connect the first electrode of the second driving element and a gate electrode of the first driving element.

### CROSS-REFERENCE TO RELATED APPLICATION

This application claims priority to Korean Patent Application No. 10-2024-0131542, filed in the Republic of Korea on Sep. 27, 2024, the disclosure of which is incorporated by reference in its entirety into the present application.

### BACKGROUND

### Field

The present disclosure relates to a pixel circuit and a display device including the same.

### Discussion of the Related Art

Various flat panel display devices such as a liquid crystal display device, an electroluminescent display device, and the like are known. The electroluminescent display device can display an input image by emitting light by itself without a backlight by using the light-emitting elements disposed on each of the pixels. The light-emitting elements of the electroluminescent display device can be divided into an organic light-emitting element and an inorganic light-emitting element according to the material of the light-emitting layer.

Recently, a display device that uses a light-emitting diode (LED), an inorganic light-emitting element, as a light-emitting element of a pixel has attracted attention as a next-generation display device. Since LEDs are made of inorganic materials, they do not require a separate encapsulation layer to protect organic materials from moisture, and they are more reliable and have a longer lifespan than organic light-emitting diodes (OLEDs). In addition, LEDs have a fast lighting speed, excellent luminous efficiency, and impact resistance.

### SUMMARY OF THE DISCLOSURE

In a display device, each of a plurality of pixels includes a driving element that controls a driving current flowing to the light-emitting element based on a voltage Vgs between the gate electrode and the source electrode. However, the electrical characteristics of the driving element can degrade over its driving time, exhibiting pixel-to-pixel variation.

In addition, since the driving current is used to control the emission time of the light-emitting element, it can be difficult to operate the light-emitting element only at its maximum efficiency range, resulting in high power consumption.

The present disclosure is directed to solving or addressing all the above-described necessity and problems and other limitations associated with the related art.

The present disclosure provides a pixel circuit capable of reducing power consumption and a display device including the same.

It should be noted that objects of the present disclosure are not limited to the above-described objects, and other objects of the present disclosure will be apparent to those skilled in the art from the following descriptions.

A pixel circuit according to embodiments of the present disclosure can include a light-emitting element; a first driving element configured to drive the light-emitting element; a second driving element configured to drive the first driving element; a capacitor connected to a gate electrode of the second driving element; a first switch element configured to apply an initialization voltage to a second electrode of the capacitor; a second switch element configured to apply a data voltage to a first electrode of the capacitor; a third switch element configured to apply an off voltage to the first electrode of the capacitor; a fourth switch element connected between the second electrode of the capacitor and a first electrode of the second driving element; a fifth switch element configured to connect the first electrode of the second driving element and a gate electrode of the first driving element; a sixth switch element configured to apply a pixel driving voltage to the gate electrode of the first driving element; and a seventh switch element connected between the light-emitting element and the first driving element.

A display device according to embodiments of the present disclosure can include a pixel array in which a plurality of data lines, a plurality of gate lines, and a plurality of pixel circuits are arranged; a data driver configured to output a data voltage to the plurality of data lines; and a gate driver configured to output a gate signal to the plurality of gate lines, each of the pixel circuits includes: a light-emitting element; a first driving element configured to drive the light-emitting element; a second driving element configured to drive the first driving element; a capacitor connected to a gate electrode of the second driving element; a first switch element configured to apply an initialization voltage to a second electrode of the capacitor; a second switch element configured to apply a data voltage to a first electrode of the capacitor; a third switch element configured to apply an off voltage to the first electrode of the capacitor; a fourth switch element connected between the second electrode of the capacitor and a first electrode of the second driving element; a fifth switch element configured to connect the first electrode of the second driving element and a gate electrode of the first driving element; a sixth switch element configured to apply a pixel driving voltage to the gate electrode of the first driving element; and a seventh switch element connected between the light-emitting element and the first driving element.

The aspects of present disclosure provide a first driving element that drives a light-emitting element and a second driving element that drives the first driving element. By controlling the turn-on time of the second driving element, which allows the first driving element to be turned off using the data voltage, the emission time of the light-emitting element can be adjusted according to the data voltage, enabling the light-emitting element to be utilized in its maximum efficiency range.

According to aspects of the present disclosure, the emission time of the light-emitting element can be adjusted by the data voltage without pixel-to-pixel variation by utilizing the first driving element as a switch element and compensating for the threshold voltage of the second driving element.

According to aspects of the present disclosure, pulse width modulation (PWM) driving of the light-emitting element can be achieved by utilizing its optimal efficiency range.

According to aspects of the present disclosure, low-power operation of the light-emitting element can be achieved by utilizing its optimal efficiency range.

The effects of the present disclosure are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, in which:

FIG. 1 is a block diagram showing a display device according to embodiments of the present disclosure;

FIG. 2 is a diagram showing a pixel circuit according to embodiments of the present disclosure;

FIG. 3 is a diagram illustrating driving timings of the pixel circuit shown in FIG. 2 according to embodiments of the present disclosure;

FIGS. 4A to 4D are diagrams for explaining an operation principle of the pixel circuit based on the driving timings in FIG. 3 according to embodiments of the present disclosure; and

FIGS. 5A and 5B are diagrams illustrating an emission time based on a data voltage according to embodiments of the present disclosure.

### DETAILED DESCRIPTION OF THE EMBODIMENTS

Advantages and features of the present disclosure and methods of achieving them will become apparent with reference to preferable embodiments, which are described in detail, in conjunction with the accompanying drawings. However, the present disclosure is not limited to the embodiments to be described below and can be implemented in different forms, the embodiments are only provided to completely disclose the present disclosure and completely convey the scope of the present disclosure to those skilled in the art.

Since the shapes, sizes, proportions, angles, numbers, and the like disclosed in the drawings for describing the embodiments of the present disclosure are only examples, the present disclosure is not limited to the illustrated items. The same reference numerals indicate the same components throughout the specification. Further, in describing the present disclosure, when it is determined that a detailed description of related known technology can unnecessarily obscure the gist of the present disclosure, the detailed description thereof may be omitted or may be provided briefly.

When ‘including,’ ‘having,’ ‘consisting,’ and the like mentioned in the present specification are used, other parts can be added unless ‘only’ is used. A case in which a component is expressed in a singular form includes a plural form unless explicitly stated otherwise.

In interpreting the components, it should be understood that an error range is included even when there is no separate explicit description.

In the case of a description of a positional relationship, for example, when the positional relationship of two parts is described as ‘on,’ ‘at an upper portion,’ ‘at a lower portion,’ ‘next to, and the like, one or more other parts can be located between the two parts unless ‘immediately’ or ‘directly’ is used.

Although the terms such as first, second, and the like are used to describe various components, these components are not limited by these terms. These terms are only used to distinguish one component from another and may not define order or sequence. Accordingly, a first component, which is mentioned below, can also be a second component within the technical spirit of the present disclosure. Further, the term “can” fully encompasses all the meanings and coverages of the term “may” and vice versa.

The same reference numerals can refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings. All the components of each display device and panel according to all embodiments of the present disclosure are operatively coupled and configured.

In a display device of the present disclosure, the pixel circuit and the gate driving circuit can include a plurality of transistors. Transistors can be implemented as oxide thin film transistors (oxide TFTs) including an oxide semiconductor, low temperature polysilicon (LTPS) TFTs including low temperature polysilicon, or the like.

A gate signal swings between a gate-on voltage and a gate-off voltage. The gate-on voltage is set to a voltage higher than a threshold voltage of a transistor, and the gate-off voltage is set to a voltage lower than the threshold voltage of the transistor.

The transistor is turned on in response to the gate-on voltage and is turned off in response to the gate-off voltage. In the case of the n-channel transistor, a gate-on voltage can be a gate high voltage, and a gate-off voltage can be a gate low voltage. In the case of the p-channel transistor, a gate-on voltage can be a gate low voltage, and a gate-off voltage can be a gate high voltage.

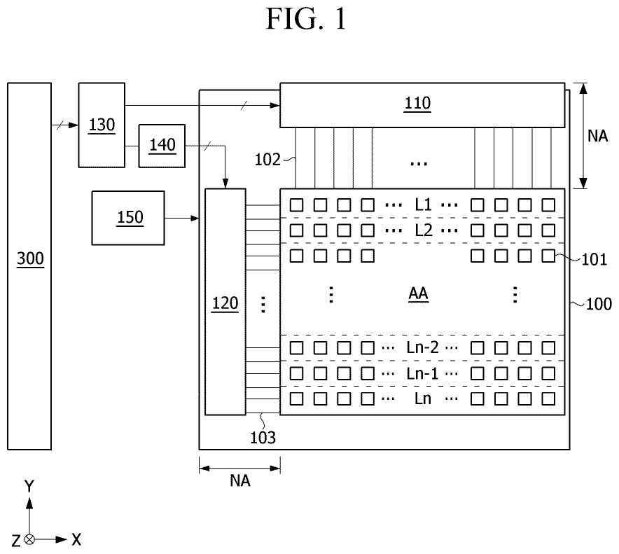

FIG. 1 is a block diagram showing a display device according to one or more embodiments of the present disclosure.

Referring to FIG. 1, the display device according to an embodiment of the present disclosure includes a display panel 100, and a display panel driving circuit for writing pixel data to pixels of the display panel 100. Additionally, the display device includes a power supply 150.

The display panel 100 can be, but not limited to, a panel having a rectangular structure with a length in an X-axis direction, a width in a Y-axis direction, and a thickness in a Z-axis direction. For example, the display panel 100 can be a heterogeneous panel of which at least a portion is curved or elliptical.

The display area AA (or active area) of the display panel 100 includes a pixel array to display an input image. The pixel array includes a plurality of data lines 102, a plurality of gate lines 103 crossing the data lines 102, and pixels 101 arranged in a matrix form. The display panel 100 can further include power lines commonly connected to the pixels 101. The power lines can be commonly connected to pixel circuits to supply a voltage required for driving pixels 101 to the pixels 101.

Each of the pixels 101 can be divided into a red sub-pixel, a green sub-pixel, and a blue sub-pixel for color implementation. Each pixel can further include a white sub-pixel. Each sub-pixel includes a pixel circuit for driving a light emitting element. The light emitting element can include an OLED or an inorganic light emitting diode (LED). Each pixel circuit is connected to the data lines, the gate lines, and the power lines. In the following description, a pixel can be interpreted as a sub-pixel.

The pixels can be arranged as real color pixels and pentile pixels. A pentile pixel can realize a higher resolution than a real color pixel by driving two sub-pixels with different colors as one pixel 101 and using a preset pixel rendering algorithm. This pixel rendering algorithm can compensate for insufficient color representation in each pixel with the color of light emitted from adjacent pixels.

The display area AA includes a plurality of pixel lines L1 to Ln, where n can be a real number such as a positive integer. Each of the pixel lines L1 to Ln includes one line of pixels arranged along the line direction (e.g., X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 can be implemented with a non-transmissive display panel or a transmissive display panel. The transmissive display panel can be applied to a transparent display device in which an image is displayed on the screen and a real object in the background is visible. The display panel 100 can be made of a flexible display panel.

The power supply 150 receives an input voltage applied from the host system 300 and outputs a voltage needed to drive the pixels 101 of the display panel 100 and the display panel driving circuit. To this end, the power supply 150 can include a direct current to direct current converter (DC-DC converter). The DC-DC converter can include a charge pump, a regulator, a buck converter, a boost converter, and the like. The power supply 150 can output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage can be supplied to the level shifter 140 and the gate driver 120. Voltages such as pixel driving voltage, cathode voltage, and reference voltage can be supplied to the pixels 101 through the power lines commonly connected to the pixels 101.

The display panel driving circuit writes pixel data of the input image to the pixels 101 of the display panel 100 under the control of the timing controller 130. The display panel driving circuit includes a data driver 110 and a gate driver 120.

The display panel driving circuit can further include a touch sensor driver for driving touch sensors. The data driver 110 and the touch sensor driver can be integrated into one source drive IC.

The data driver 110 receives pixel data of the input image as a digital signal from the timing controller 130 and outputs a data voltage. The data driver 110 can receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. Additionally, the digital data can include mode selection data for selecting first mode and second mode. The DAC converts the pixel data into a gamma compensation voltage and outputs a data voltage of the pixel data.

The gate driver 120 can be formed on the display panel 100 together with the circuit elements and wiring lines of the display area AA. The gate driver 120 can be disposed in at least one of left and right non-display areas NA (non-active areas) outside the display area AA in the display panel 100 or at least a part thereof can be disposed within the display area AA.

The gate driver 120 sequentially outputs pulses of the gate signals to the gate lines 103 under the control of the timing controller 130. The gate driver 120 can sequentially supply the gate signals to the gate lines 103 by shifting the pulses of the gate signals using shift registers. When a plurality of gate signals are applied to each pixel, the gate driver 120 can include a plurality of shift registers. The gate signal can include a scan signal being input to the pixel circuit through a plurality of gate lines, and an emission signal (or EM signal).

The timing controller 130 receives digital video data of an input image and a timing signal synchronized with this data from the host system 300. The timing signal can include a vertical synchronization signal Vsync, a horizontal synchronization signal Hsync, and a data enable signal DE. Since the vertical period and horizontal period can be known by counting the data enable signal DE, the vertical synchronization signal Vsync and the horizontal synchronization signal Hsync can be omitted. The horizontal synchronization signal Hsync and the data enable signal DE have a periodicity of 1 horizontal period (1H).

The timing controller 130 can control the display panel driving circuit by generating a data timing control signal for controlling the operation timing of the data driver 110 and a gate timing control signal for controlling the operation timing of the gate driver 120 based on the timing signals Vsync, Hsync, DE received from the host system 300. The timing controller 130 can synchronize the data driver 110 and the gate driver 120 by controlling the operation timing of the display panel driving circuit.

The gate timing control signal output from the timing controller 130 can be input to the shift register of the gate driver 120 through the level shifter 140. The level shifter 140 can convert a voltage of the gate timing control signal received from the timing controller 130 to a swing width between the gate-on voltage and the gate-off voltage and supply it to the gate driver 120.

The host system 300 can include a main board of one of a television system, a set-top box, a navigation system, a personal computer (PC), a vehicle system, a mobile terminal, and a wearable terminal. The host system 300 can scale an image signal from a video source according to the resolution of the display panel 100, and can transmit it to the timing controller 130 together with the timing signals.

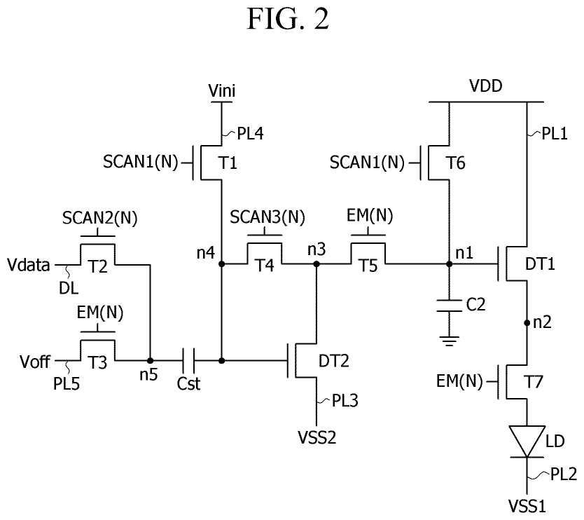

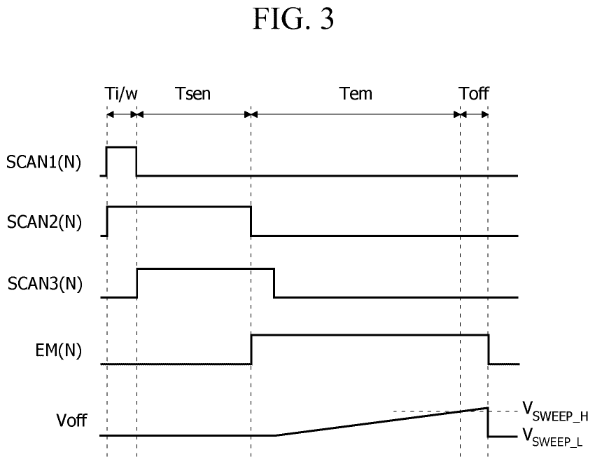

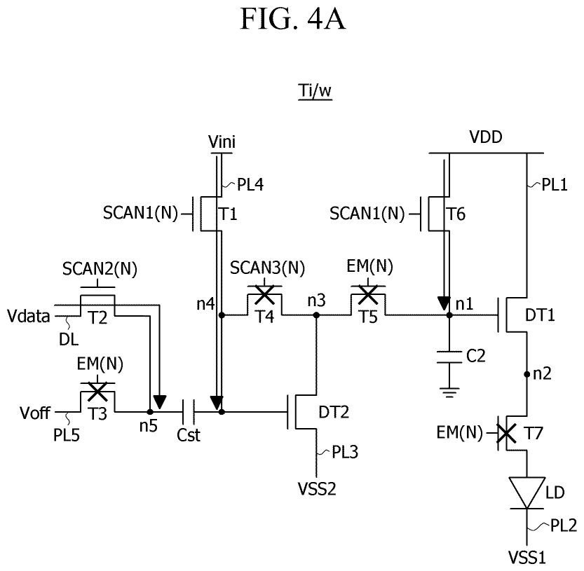

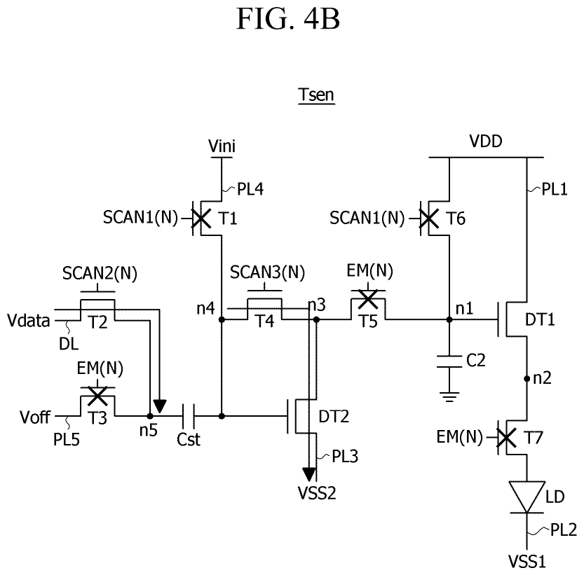

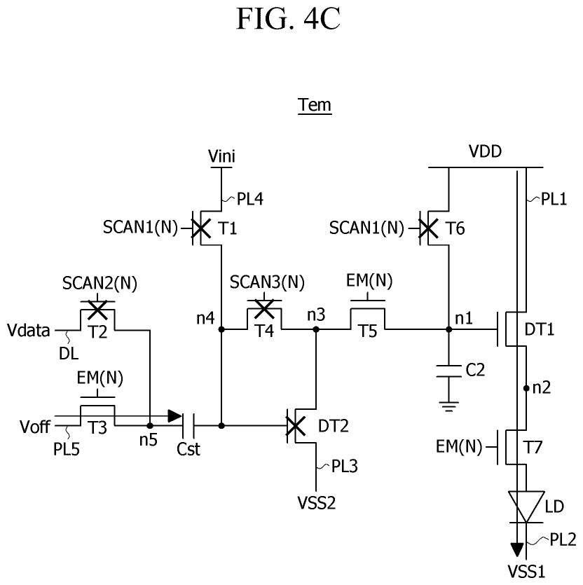

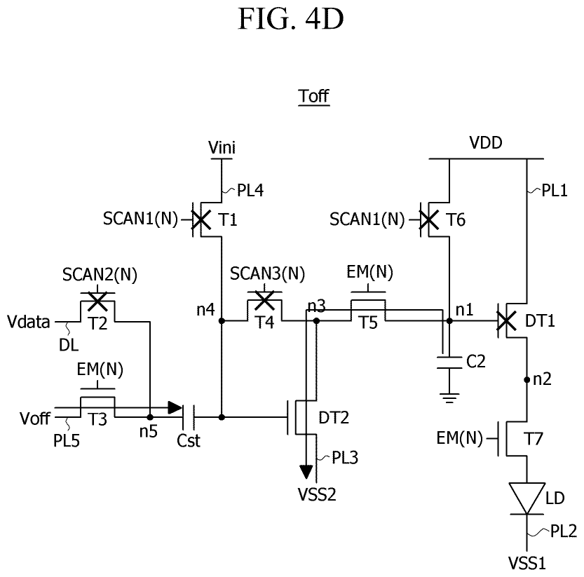

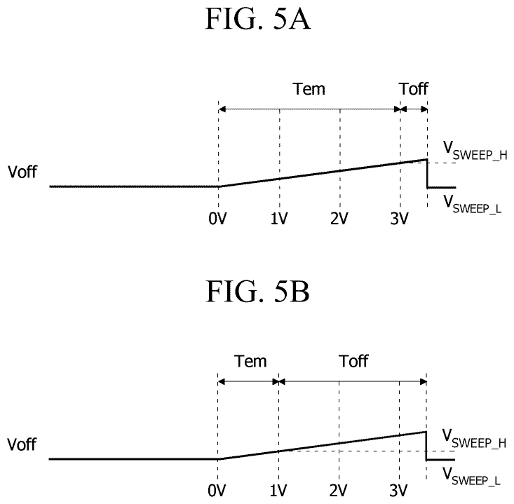

FIG. 2 is a diagram illustrating a pixel circuit according to embodiments of the present disclosure, FIG. 3 is a diagram illustrating the driving timing of the pixel circuit shown in FIG. 2, FIGS. 4A to 4D are diagrams for describing the operating principle of the pixel circuit according to FIG. 3, and FIGS. 5A and 5B are diagrams for describing the emission time according to the data voltage.

Referring to FIGS. 2 and 3, a pixel circuit according to embodiments of the present disclosure includes a light-emitting element LD, a first driving element DT1 and a second driving element D2, which supply current to the light-emitting element LD, a plurality of switch elements T1, T2, T3, T4, T5, T6 and T7 switching a current path connected to the first driving element DT1, a first capacitor Cst, and a second capacitor C2. The driving element DT1 and DT2 and the switch elements T1, T2, T3, T4, T5, T6 and T7 can be implemented with, but not limited to, n-channel transistors.

The light-emitting element LD can include an anode electrode, a cathode electrode, and an emission layer. The cathode electrode of the light-emitting element LD can be connected to a second power line PL2 to which a first pixel base voltage VSS1 is applied. The anode electrode of the light-emitting element LD can be connected to the first driving element DT1. The light-emitting element LD can be a light-emitting element such as an OLED, mini-LED, or micro-LED, but is not limited thereto. In the case of a mini-LED or micro-LED, the light-emitting element LD can have a vertical structure in which electrodes are arranged on the upper and lower parts of a semiconductor chip in which the light-emitting element LD is integrated, but is not limited thereto. The semiconductor chip in which the light-emitting element LD is integrated can be implemented in a lateral structure or a flip chip structure.

The first driving element DT1 can drive the light-emitting element LD in response to the voltage of a first node n1. The first driving element DT1 includes a gate electrode connected to the first node n1, a first electrode connected to a first power line PL1 to which a pixel driving voltage VDD is applied, and a second electrode connected to a second third node n2.

The second driving element DT2 can drive the first driving element DT1 in response to the voltage of a fourth node n4. The second driving element DT2, when turned on by the voltage of the fourth node n4, connects a third power line PL3 to which a second pixel base voltage VSS2 is applied to the first node n1, discharging the voltage of the first node n1 to the second pixel base voltage VSS2, and thereby turning off the first driving element DT1 and controlling the light emission time of the light-emitting element LD. The second driving element DT2 includes a gate electrode connected to the fourth node n4, a first electrode connected to the third node n3, and a second electrode connected to the third power line PL3.

In an embodiment, the first driving element DT1 and the second driving element DT2 can be used to control the light emission time of the light-emitting element LD. The first driving element DT1 can be used as a switching element, and the second driving element DT2 can control the time at which the first driving element DT1 is turned on.

A first switch element T1 supplies an initialization voltage Vini to the fourth node n4 in response to a first scan signal [SCAN1(N)]. The first switch element T1 includes a gate electrode to which the first scan signal [SCAN1(N)] is applied, a first electrode connected to a fourth power line PLA to which the initialization voltage Vini is applied, and a second electrode connected to the fourth node n4. Here, N can be a real number such as a positive integer.

A second switch element T2 supplies a data voltage Vdata to a fifth node n5 in response to a second scan signal [SCAN2(N)]. The second switch element T2 includes a gate electrode to which the second scan signal [SCAN2(N)] is applied, a first electrode connected to a data line DL to which the data voltage Vdata is applied, and a second electrode connected to the fifth node n5.

A third switch element T3 applies an off voltage Voff to the fifth node n5 in response to an emission control signal [EM(N)]. The third switch element T3 includes a gate electrode to which the emission control signal [EM(N)] is applied, a first electrode connected to a fifth power line PL5 to which the off voltage Voff is applied, and a second electrode connected to the fifth node n5.

A fourth switch element T4 connects the fourth node n4 and the third node n3 in response to a third scan signal [SCAN3(N)]. The fourth switch element T4 includes a gate electrode to which the third scan signal [SCAN3(N)] is applied, a first electrode connected to the fourth node n4, and a second electrode connected to the third node n3.

A fifth switch element T5 connects the third node n3 and the first node n1 in response to the emission control signal [EM(N)]. The fifth switch element T5 includes a gate electrode to which the emission control signal [EM(N)] is applied, a first electrode connected to the third node n3, and a second electrode connected to the first node n1.

A sixth switch element T6 connects the first power line PL1 to the first node n1 in response to the first scan signal [SCAN1(N)]. The sixth switch element T6 includes a gate electrode to which the first scan signal [SCAN1(N)] is applied, a first electrode connected to the first power line PL1, and a second electrode connected to the first node n1.

A seventh switch element T7 connects the second node n2 to the anode electrode of the light-emitting element LD in response to the emission control signal [EM(N)]. The seventh switch element T7 includes a gate electrode to which the emission control signal [EM(N)] is applied, a first electrode connected to the second node n2, and a second electrode connected to an anode electrode of the light-emitting element LD.

The first capacitor Cst is connected between the fifth node n5 and the fourth node n4. The first capacitor Cst can store the threshold voltage Vth of the second driving element DT2.

The second capacitor C2 is connected between the first node n1 and the ground. The second capacitor C2 can stabilize the voltage applied to the first node n1. For example, the second capacitor C2 can maintain the pixel driving voltage VDD at the first node n1 when the pixel driving voltage VDD is applied to the first node n1.

The pixel circuit described here is just one example and is not necessarily limited to the description as provided above.

The pixel circuit according to the embodiments discussed herein can operate in a driving sequence of an initialization and data writing stage Ti/w, a sensing stage Tsen, an emission stage Tem, and a non-emission stage Toff, as shown in FIG. 3

Referring to FIGS. 3 and 4A, in the initialization and data writing stage Ti/w, the third to fifth switch elements T3, T4, T5 and the seventh switch element T7 are turned off, and the first switch element T1 is turned on, allowing the initialization voltage Vini to be applied to the fourth node n4 for initialization. This results in the voltage of the fourth node n4 being ‘Vini’.

The second switch element T2 is turned on to apply the data voltage Vdata to the fifth node n5. This results in the voltage of the fifth node n5 being ‘Vdata’.

The sixth switch element T6 is turned on to apply the pixel driving voltage VDD to the first node n1. This causes the voltage of the first node n1 to be ‘VDD’.

Referring to FIG. 3 and FIG. 4B, in the sensing stage Tsen, the second switch element T2 is turned on to apply the data voltage Vdata to the fifth node n5, the fourth switch element T4 is turned on, and the second driving element DT2 becomes a diode connection circuit, causing the voltage of the fourth node n4 to be discharged from “Vini” to “VSS2+Vth”. At this time, since VSS2=0, the threshold voltage Vth of the second driving element DT2 is sensed and stored in the first capacitor Cst connected to the fourth node n4. This causes the voltage of the fifth node n5 to be ‘Vdata’, the voltage of the fourth node n4 to be ‘VSS2+Vth’, and the voltage of the first node n1 to remain at ‘VDD’.

In an embodiment, since the first driving element DT1 is used as a switch element, the threshold voltage of the second driving element DT2 is compensated without compensating the threshold voltage of the first driving element DT1.

Referring to FIGS. 3 and 4C, in the emission stage Tem, the third switch element T3 is turned on to apply the off voltage Voff to the first capacitor Cst, changing the voltage of the fourth node n4. In this case, the second driving element DT2 can be in a turn-off state when the applied off voltage Voff is lower than the data voltage Vdata.

The voltage of the first node n1 is ‘VDD’, the voltage of the fifth node n5 is ‘Voff’, and the voltage of the fourth node n4 is ‘VSS2+Vth+ (Voff−Vdata)’. Here, the off voltage Voff has a variable voltage value, which can be, but is not limited to, a voltage value that rises from a first voltage level V_{SWEEP_L} and a second voltage level V_{SWEEP_H} having a predetermined magnitude.

The seventh switch element T7 is turned on to allow current to flow through the first driving element DT1, thereby causing the light-emitting element LD to emit light.

Referring to FIGS. 3 and 4D, in the non-emission stage Toff, the voltage of the fourth node n4 rises as the third switch element T3 remains turned on and the off voltage Voff rises to the second voltage level V_{SWEEP_H}, thereby causing the second driving element DT2 to turn on, discharging the voltage of the first node n1 to the second pixel base voltage VSS2, and consequently turning off the first driving element DT1, resulting in the light-emitting element LD not emitting.

The voltage of the fifth node n5 is ‘Voff=V_{SWEEP_H}’, the voltage of the first node n1 is ‘VSS2’, and the voltage of the fourth node n4 is ‘VSS2+Vth+ (Voff-Vdata)’, thus exceeding the gate-on voltage sufficient to turn on the second driving element DT2, which causes the first driving element DT1 to turn off when the second driving element DT2 turns on.

In this case, the voltage of the fourth node n4 varies with the data voltage Vdata and the off voltage Voff, and as the off voltage Voff is a voltage that rises to a constant magnitude, the time required to reach the gate-on voltage can depend on the data voltage Vdata. The second driving element DT2 can be turned off when the off voltage Voff is lower than the data voltage Vdata and can be turned on when the off voltage Voff is higher than or equal to the data voltage Vdata.

For example, assuming that the data voltage Vdata is 3 V, the off voltage Voff must be 3 V in order to attain the gate-on voltage, as shown in FIG. 5A.

In contrast, as shown in FIG. 5B, assuming that the data voltage Vdata is 1 V, the gate-on voltage is attained when the off voltage Voff is 1 V, resulting in a shorter emission time.

The second voltage level V_{SWEEP_H} of the off voltage Voff can have a predetermined magnitude higher than that of the data voltage Vdata.

Consequently, the emission time of the light-emitting element can vary depending on the data voltage Vdata. In other words, in the embodiments discussed above, a higher data voltage results in a shorter emission time, while a lower data voltage leads to a longer emission time, as determined by the data voltage and the off voltage.

Although the embodiments of the present disclosure have been described in more detail with reference to the accompanying drawings, the present disclosure is not limited thereto and can be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A pixel circuit comprising:
a light-emitting element;
a first driving element configured to drive the light-emitting element;
a second driving element configured to drive the first driving element;
a capacitor connected to a gate electrode of the second driving element;
a first switch element configured to apply an initialization voltage to a second electrode of the capacitor;
a second switch element configured to apply a data voltage to a first electrode of the capacitor;
a third switch element configured to apply an off voltage to the first electrode of the capacitor;
a fourth switch element connected between the second electrode of the capacitor and a first electrode of the second driving element;
a fifth switch element configured to connect the first electrode of the second driving element and a gate electrode of the first driving element;
a sixth switch element configured to apply a pixel driving voltage to the gate electrode of the first driving element; and
a seventh switch element connected between the light-emitting element and the first driving element.

2. The pixel circuit of claim 1, wherein the off voltage includes a voltage that rises to a predetermined magnitude.

3. The pixel circuit of claim 2, wherein an emission time of the light-emitting element varies with a magnitude of the data voltage.

4. The pixel circuit of claim 1, wherein:
the first driving element includes the gate electrode connected to a first node, a first electrode to which the pixel driving voltage is applied, and a second electrode connected to a second node,
the second driving element includes the gate electrode connected to a fourth node, a first electrode connected to a third node, and a second electrode to which a pixel base voltage is applied, and
the capacitor includes the first electrode connected to a fifth node, and the second electrode connected to the fourth node.

5. The pixel circuit of claim 4, wherein:
the first switch element includes a gate electrode to which a first scan signal is applied, a first electrode to which the initialization voltage is applied, and a second electrode connected to the fourth node,
the second switch element includes a gate electrode to which a second scan signal is applied, a first electrode to which the data voltage is applied, and a second electrode connected to the fifth node, and
the third switch element includes a gate electrode to which an emission control signal is applied, a first electrode to which the off voltage is applied, and a second electrode connected to the fifth node.

6. The pixel circuit of claim 5, wherein:
the fourth switch element includes a gate electrode to which a third scan signal is applied, a first electrode connected to the fourth node, and a second electrode connected to the third node,
the fifth switch element includes a gate electrode to which the emission control signal is applied, a first electrode connected to the third node, and a second electrode connected to the first node,
the sixth switch element includes a gate electrode to which the first scan signal is applied, a first electrode to which the pixel driving voltage is applied, and a second electrode connected to the first node, and
the seventh switch element includes a gate electrode to which the emission control signal is applied, a first electrode connected to the second node, and a second electrode connected to the light-emitting element.

7. The pixel circuit of claim 6, wherein the pixel circuit is operated in the sequence of an initialization and data writing stage, a sensing stage, an emission stage, and a non-emission stage, and
wherein, in the initialization and data writing stage, the first switch element is turned on to apply the initialization voltage to the fourth node, the second switch element is turned on to apply the data voltage to the fifth node, and the sixth switch element is turned on to apply the pixel driving voltage to the first node.

8. The pixel circuit of claim 7, wherein, in the sensing stage, the second switch element is turned on to apply the data voltage to the fifth node, and the fourth switch element is turned on to cause a threshold voltage of the second driving element to be stored in the capacitor.

9. The pixel circuit of claim 8, wherein, in the emission stage, the third switch element is turned on to apply the off voltage to the fifth node, and the seventh switch element is turned on to allow the light-emitting element to emit light.

10. The pixel circuit of claim 9, wherein, in the non-emission stage, the third switch element is turned on to apply the off voltage to the fifth node, and the fifth switch element is turned on to discharge the voltages of the first node and the third node to the pixel base voltage.

11. A display device comprising:
a pixel array including a plurality of data lines, a plurality of gate lines, and a plurality of pixel circuits;
a data driver configured to output a data voltage to the plurality of data lines; and
a gate driver configured to output a gate signal to the plurality of gate lines,
wherein each of at least one of the plurality of pixel circuits includes:
a light-emitting element;
a first driving element configured to drive the light-emitting element;
a second driving element configured to drive the first driving element;
a capacitor connected to a gate electrode of the second driving element;
a first switch element configured to apply an initialization voltage to a second electrode of the capacitor;
a second switch element configured to apply a data voltage to a first electrode of the capacitor;
a third switch element configured to apply an off voltage to the first electrode of the capacitor;
a fourth switch element connected between the second electrode of the capacitor and a first electrode of the second driving element;
a fifth switch element configured to connect the first electrode of the second driving element and a gate electrode of the first driving element;
a sixth switch element configured to apply a pixel driving voltage to the gate electrode of the first driving element; and
a seventh switch element connected between the light-emitting element and the first driving element.

12. The display device of claim 11, wherein:
the first driving element includes the gate electrode connected to a first node, a first electrode to which the pixel driving voltage is applied, and a second electrode connected to a second node,
the second driving element includes the gate electrode connected to a fourth node, a first electrode connected to a third node, and a second electrode to which a pixel base voltage is applied, and
the capacitor includes the first electrode connected to a fifth node, and the second electrode connected to the fourth node.

13. The display device of claim 12, wherein:
the first switch element includes a gate electrode to which a first scan signal is applied, a first electrode to which the initialization voltage is applied, and a second electrode connected to the fourth node,
the second switch element includes a gate electrode to which a second scan signal is applied, a first electrode to which the data voltage is applied, and a second electrode connected to the fifth node, and
the third switch element includes a gate electrode to which an emission control signal is applied, a first electrode to which the off voltage is applied, and a second electrode connected to the fifth node.

14. The display device of claim 13, wherein:
the fourth switch element includes a gate electrode to which a third scan signal is applied, a first electrode connected to the fourth node, and a second electrode connected to the third node,
the fifth switch element includes a gate electrode to which the emission control signal is applied, a first electrode connected to the third node, and a second electrode connected to the first node,
the sixth switch element includes a gate electrode to which the first scan signal is applied, a first electrode to which the pixel driving voltage is applied, and a second electrode connected to the first node, and
the seventh switch element includes a gate electrode to which the emission control signal is applied, a first electrode connected to the second node, and a second electrode connected to the light-emitting element.

15. The display device of claim 14, wherein the pixel circuit is operated in the sequence of an initialization and data writing stage, a sensing stage, an emission stage, and a non-emission stage, and
wherein, in the initialization and data writing stage, the first switch element is turned on to apply the initialization voltage to the fourth node, the second switch element is turned on to apply the data voltage to the fifth node, and the sixth switch element is turned on to apply the pixel driving voltage to the first node.

16. The display device of claim 15, wherein, in the sensing stage, the second switch element is turned on to apply the data voltage to the fifth node, and the fourth switch element is turned on to cause a threshold voltage of the second driving element to be stored in the capacitor.

17. The display device of claim 16, wherein, in the emission stage, the third switch element is turned on to apply the off voltage to the fifth node, and the seventh switch element is turned on to cause the light-emitting element to emit light.

18. The display device of claim 17, wherein, in the non-emission stage, the third switch element is turned on to apply the off voltage to the fifth node, and the fifth switch element is turned on to discharge the voltages of the first node and the third node to the pixel base voltage.
